(19) United States
(12) Patent Application Publication
(10) Pub. No.: US 2025/0112293 A1
(43) Pub. Date: Apr. 3, 2025

(54) THERMAL COMPONENT FOR BATTERY PACK

(71) Applicant: Rivian IP Holdings, LLC, Irvine, CA (US)

(72) Inventors: Diana Kei Eaton, Newport Beach, CA (US); Najmeh Rahimi, Huntington Beach, CA (US)

(21) Appl. No.: 18/476,567

(22) Filed: Sep. 28, 2023

(51) Int. Cl. H01M 10/6557; B60L 50/64; H01M 10/613; H01M 10/625; H01M 10/643; H01M 10/6555; H01M 50/213; H01M 50/258

(52) U.S. Cl. CPC H01M 10/6557; B60L 50/64; H01M 10/613; H01M 10/625; H01M 10/643; H01M 10/6555; H01M 50/213; H01M 50/258; H01M 2220/20

(57) ABSTRACT

A thermal component can include an egress channel defined at least partially by a first internal wall and a second internal wall. The thermal component can include a first ingress channel defined at least partially by the first internal wall and a first external wall. The thermal component can include a second ingress channel defined at least partially by the second internal wall and a second external wall.

Battery packs can be a source of electrical power. Battery packs can be assembled with various components.

### SUMMARY

Battery cells generate heat during charge and discharge. To improve efficiency and efficacy of the battery cells, the heat can be rejected or expelled from the battery cells to reduce an overall temperature of the battery cells, to reduce a thermal gradient across each battery cell, and to reduce a thermal gradient across a battery cell matrix. The technical solution described herein provides a thermal component (e.g., a cooling plate) that includes a plurality of channels to direct flow of a coolant across the battery cells to improve the heat dissipation of the battery cells. The present disclosure provides thermal components that are configured to be disposed in a battery pack that have various flow paths and channel system configurations configured to facilitate heat dissipation from the battery cells.

At least one aspect is directed to a thermal component. The thermal component can include an egress channel defined at least partially by a first internal wall and a second internal wall. The thermal component can include a first ingress channel defined at least partially by the first internal wall and a first external wall. The thermal component can include a second ingress channel defined at least partially by the second internal wall and a second external wall.

At least one aspect is directed to a battery pack. The battery pack can include a housing. The battery pack can include a plurality of battery cells disposed in the housing. The battery pack can include a thermal component disposed in the housing. The thermal component can be configured to interface with the plurality of battery cells. The thermal component can extend along a length of the battery pack. The thermal component can include an egress channel defined at least partially by a first internal wall and a second internal wall. The thermal component can include a first ingress channel defined at least partially by the first internal wall and a first external wall. The thermal component can include a second ingress channel defined at least partially by the second internal wall and a second external wall.

At least one aspect is directed to a method of assembling a battery pack. The method can include providing a thermal component. The thermal component can include an egress channel defined at least partially by a first internal wall and a second internal wall. The thermal component can include a first ingress channel defined at least partially by the first internal wall and a first external wall. The thermal component can include a second ingress channel defined at least partially by the second internal wall and a second external wall. The method can include coupling a plurality of battery cells with the thermal component. The method can include disposing the thermal component in a housing of a battery pack.

At least one aspect is directed to an electric vehicle. The electric vehicle can include a battery pack. The battery pack can include a housing. The battery pack can include a plurality of battery cells disposed in the housing. The battery pack can include a thermal component disposed in the housing. The thermal component can be configured to interface with the plurality of battery cells. The thermal component can extend along a length of the battery pack. The thermal component can include an egress channel defined at least partially by a first internal wall and a second internal wall. The thermal component can include a first ingress channel defined at least partially by the first internal wall and a first external wall. The thermal component can include a second ingress channel defined at least partially by the second internal wall and a second external wall.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a perspective view of an example battery assembly, in accordance with some aspects.

FIG. 2 depicts a perspective view of a portion of an example thermal component, in accordance with some aspects.

FIG. 3 depicts a perspective view of a portion of an example thermal component, in accordance with some aspects.

FIG. 4 depicts a perspective view of a portion of an example thermal component, in accordance with some aspects.

FIG. 5 depicts a perspective view of a portion of an example thermal component, in accordance with some aspects.

FIG. 6 depicts a perspective view of a portion of an example thermal component, in accordance with some aspects.

FIG. 7 depicts a perspective view of an example thermal component, in accordance with some aspects.

FIG. 8 depicts a perspective view of a portion of an example battery assembly, in accordance with some aspects.

FIG. 9 depicts a perspective view of an example battery module, in accordance with some aspects.

FIG. 10 depicts a top view of an example battery module, in accordance with some aspects.

FIG. 11 depicts a perspective view of an example battery pack, in accordance with some aspects.

FIG. 12 depicts a cross-sectional side view of an example electric vehicle, in accordance with some aspects.

FIG. 13 depicts a block diagram of an example method of assembling a battery pack, in accordance with some aspects.

### DETAILED DESCRIPTION

Following below are more detailed descriptions of various concepts related to, and implementations of, methods, apparatuses, and systems of a thermal component for a battery pack. The various concepts introduced above and discussed in greater detail below may be implemented in any of numerous ways.

The present disclosure is directed to systems and methods of cooling battery cells in a battery pack. The disclosed solutions have the technical advantage of reducing the overall temperature of a battery cell, reducing a temperature gradient across the battery cell, and reducing a temperature gradient across a matrix of battery cells. The disclosed solutions can include a thermal component configured to capture heat generated by battery cells of a battery pack to reduce the temperature of the battery cells. For example, a coolant can flow through the thermal component to capture the heat and move the heat away from the battery cells. The thermal component can extend between two rows of battery cells such that a first surface of the thermal component can interface with the first row and a second surface can interface with the second row.

The thermal component can include a plurality of channels to facilitate the heat transfer between the battery cells and the thermal component. A first subset of the channels can be ingress channels. The ingress channels can receive a fluid into the thermal component and can have the fluid flowing in a first direction. A second subset of the channels can be egress channels. The egress channels can expel the fluid from the thermal component and can have fluid flowing in a second direction, opposite the first direction. The fluid from the ingress channels can travel from a first end of the thermal component to a second end. At the second end, the fluid can transfer from the ingress channels to the egress channels and flow from the second end back to the first end. The fluid in the ingress channels can have a lower temperature than the fluid in the egress channels because the fluid in the ingress channels can be passing by the battery cells for a first time and capturing heat for the first time. The fluid in the egress channels can already have captured some heat from the battery cells from the ingress channels and can be making a second pass along the thermal component.

The plurality of channels can have a variety of configurations. For example, the thermal component can have a single column of channels. The channels can extend from the top of the thermal component to the bottom. The channels can be arranged such that the ingress and egress channels alternate. The channels can be arranged such that the outermost channels (e.g., the top and bottom channels) are ingress channels and the innermost channels (e.g., the middle channels) are egress channels. At least some of the channels can have fins disposed in the channels to facilitate extra heat transfer.

The thermal component can have a plurality of columns of channels. For example, the thermal component can have a first outer column, an inner column, and a second outer column. The first and second outer columns can include a plurality of ingress channels that extend along the external walls of the thermal component. The inner column can be disposed between the outer columns. The inner column can include a plurality of egress channels. A subset of the ingress channels can merge into a single egress channel.

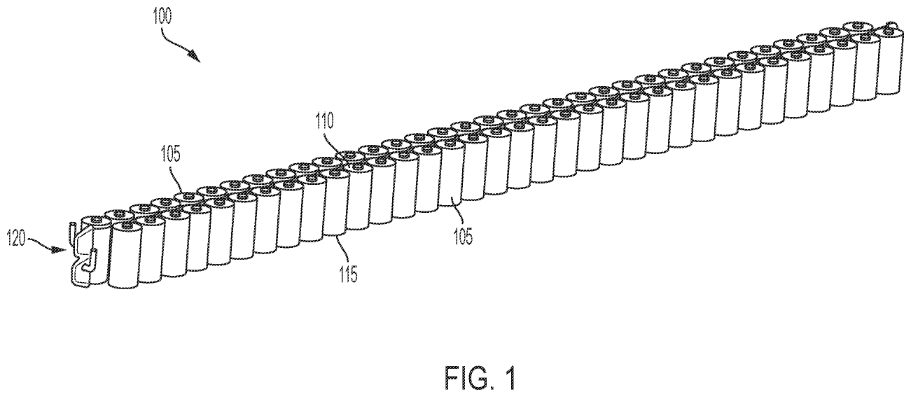

FIG. 1 depicts an example battery assembly 100. The battery assembly 100 can provide thermal control (e.g., cooling) to a heat source (e.g., a battery cell). For example, the battery assembly 100 can include at least one battery cell 105. The battery cell 105 can generate heat during charge or discharge. The battery cell 105 can have a first end, shown as cell top 110, and a second end, shown as cell bottom 115. The battery cell 105 can generate more heat at the cell top 110 than the cell bottom 115. For example, the cell top 110 may have reach a higher temperature than the cell bottom 115.

The battery cells 105 can have a variety of form factors, shapes, or sizes. For example, battery cells 105 can have a cylindrical, rectangular, square, cubic, flat, or prismatic form factor. Battery cells 105 can be assembled, for example, by inserting a winded or stacked electrode roll (e.g., a jelly roll) including electrolyte material into at least one battery cell housing. The electrolyte material, e.g., an ionically conductive fluid or other material, can generate or provide electric power for the battery cell 105. A first portion of the electrolyte material can have a first polarity, and a second portion of the electrolyte material can have a second polarity. The housing can be of various shapes, including cylindrical or rectangular, for example. Electrical connections can be made between the electrolyte material and components of the battery cell 105. For example, electrical connections with at least some of the electrolyte material can be formed at two points or areas of the battery cell 105 (e.g., a positive or anode terminal and a negative or cathode terminal).

The battery assembly 100 can include at least one thermal component 120. The thermal component 120 can be configured to control a temperature of the battery cell 105, control a temperature gradient across the battery cell 105, and control a temperature gradient across a plurality of battery cells 105. For example, the thermal component 120 can be a cooling plate. The thermal component 120 can interface a battery cell 105 and can cause heat to transfer from the battery cell 105 to the thermal component 120. The battery cell 105 can be coupled with the thermal component 120. For example, the battery cell 105 can be couple with (e.g., be bonded with) the thermal component 120 via an adhesive. The battery cell 105 can interface with the thermal component 120 via the adhesive. For example, the adhesive can be a thin layer or can be thermally conductive such that heat can transfer from the battery cell 105 to the thermal component 120.

The battery assembly 100 can include a plurality of battery cells 105. For example, a first battery cell 105 can be disposed on a first side of the thermal component 120 and a second battery cell 105 can be disposed on a second side of the thermal component 120. A first set of battery cells 105 can be disposed on the first side of the thermal component 120 and a second set of battery cells 105 can be disposed on a second side of the thermal component 120.

The thermal component 120 can have or define a channel system comprising a plurality of channels configured to guide fluid (e.g., coolant) to through the thermal component 120. The fluid can capture the heat from the battery cells 105 and remove the heat from the battery assembly 100 to control the temperature of the battery cells 105.

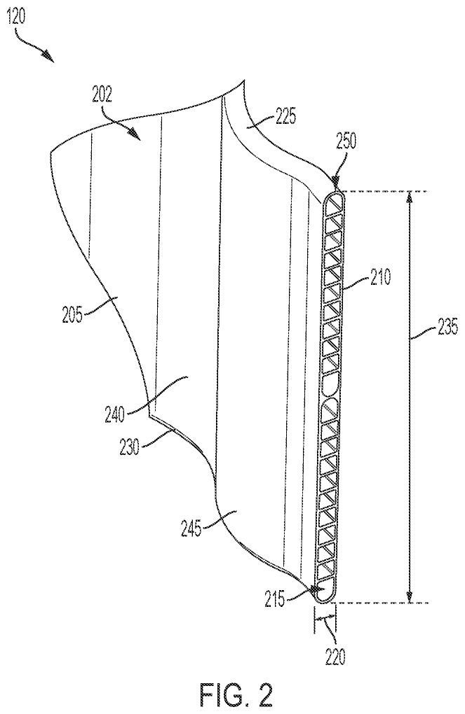

FIG. 2 depicts a portion of an example thermal component 120. The thermal component 120 can have a body 202. The body 202 can be at least partially defined by a first external wall 205 and a second external wall 210 opposite the first external wall 205. The first external wall 205 can be configured to transfer heat from a first battery cell 105 to a fluid (e.g., coolant) flowing through the thermal component 120. The second external wall 210 can be configured to transfer heat from a second battery cell 105 to the fluid flowing through the thermal component 120. The first external wall 205 can be disposed away from the second external wall 210 to define an inner volume 215 of the thermal component 120. The fluid can flow through the thermal component 120 via the inner volume 215. The inner volume 215 can extend a length of the body 202 of the thermal component 120. The first external wall 205 and the second external wall 210 can define a width or thickness of the thermal component 120, shown as component thickness 220. The component thickness 220 can be, for example, approximately 4 mm (e.g., +/−10%). The first external wall 205 and the second external wall 210 can be configured to facilitate heat transfer between a battery cell 105 and a fluid flowing through the thermal component 120. For example, the first external wall 205 and the second external wall 210 can be made of a conductive material (e.g., aluminum).

The thermal component 120 can have a top end, shown as component top 225, and a bottom end, shown as component bottom 230. The first external wall 205 and the second external wall 210 can extend between the component top 225 and the component bottom 230. The thermal component 120 can have a component height 235. The component height 235 can be measured from the component top 225 and a component bottom 230. The component height 235 can be, for example, approximately 80 mm (e.g., +/−10%). The component height 230 can be based, at least partially, on a battery cell 105. For example, a jelly roll of the battery cell 105 can generate the heat of the battery cell 105. The component height 235 can be based on a height of the jelly roll. For example, the component height 235 can be equal to, greater than, or less than the height of the jelly roll. The component height 235 can be selected to cover the full height of the jelly roll. The component height 230 can be based on a full height of the battery cell 105 or a portion thereof. For example, the component height 230 can be equal to, greater than, or less than the height of the battery cell 105.

The body 202 of the thermal component 120 can have a wavy profile. For example, the first external wall 205 and the second external wall 210 can each have at least one concave portion 240 and at last one convex portion 245. The wavy profile can be configured to at least partially surround a battery cell 105 to increase the area of contact between the battery cell 105 and the thermal component 120. For example, a battery cell 120 can be disposed in a concave portion 240 of an external wall 205, 210 such that the external wall 205, 210 wraps partially around the battery cell 105. The concave portions 240 can be configured to interface with a side of the battery cells 105. A concave portion 240 of the first external wall 105 can be opposite a convex portion 245 of the second external wall 110 and a concave portion 240 of the second external wall 210 can be opposite a convex portion 245 of the first external wall 205. Battery cells 105 can be configured to be disposed in the concave portions 240 such that a first battery cell 105 interfacing with the first external wall 205 can be offset from a second battery cell 105 interfacing with the second external wall 210. The first external wall 205 can have a plurality of concave portions 240 to interface with a first plurality of battery cells 105. The second external wall 210 can have a plurality of concave portions 240 to interface with a second plurality of battery cells 105.

The thermal component 120 can have a channel system 250. The channel system 250 can include a plurality of channels for fluid to follow to flow through the body 202 of the thermal component 120 to facilitate the heat transfer between the battery cells 105 and the thermal component 120. The channel system 250 can have a variety of channel configurations to facilitate the heat transfer. The channel system 250 can extend the full height 235 of the thermal component 120, or can extend only a portion thereof.

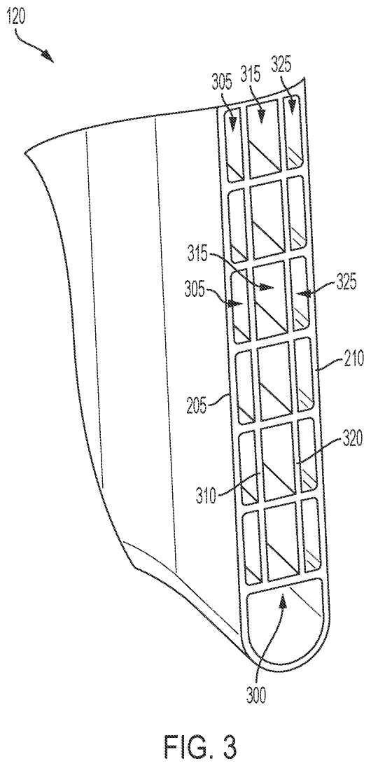

FIG. 3 depicts an example channel system 300 of a thermal component 120. For example, channel system 250 of thermal component 120 can be or include channel system 300. The channel system 300 can include at least one first ingress channel 305. The first ingress channel 305 can be at least partially defined by the first external wall 205 and a first internal wall 310. The first internal wall 310 can extend between the component top 225 and the component bottom 230. The first internal wall 310 can be parallel with the first external wall 205. The first ingress channel 305 can be configured to receive a fluid to flow through the thermal component 120. The first ingress channel 205 can extend along the length of the thermal component 120. The first ingress channel 205 can extend along the first external wall 205. The heat from a first battery cell 105 can transfer through the first external wall 205 into the fluid flowing through the first ingress channel 205. The first ingress channel 305 can have any shape. For example, the first ingress channel 305 can be rectangular.

The thermal component 120 can have a plurality of first ingress channels 305. For example, the thermal component 120 can have a column of first ingress channels 305 extending between the component top 225 and the component bottom 230. The column of first ingress channels 305 can extend along and be partially defined by the first external wall 205. Each of the first ingress channels 305 can be the same or different. For example, the channel system 300 can be asymmetrical such that the channel system 300 can provide more cooling proximate a cell top 110 of the battery cell 105 than proximate a cell bottom 115. The asymmetrical channel system 300 can, for example, have a larger first ingress channel 305 at the component top 225 and a smaller first ingress channel 305 at a component bottom 230. The component top 225 can be configured to be disposed adjacent to a cell top 110 and the component bottom 230 can be configured to be disposed adjacent to a cell bottom 115.

Channel system 300 can include at least one egress channel 315. The egress channel 315 can be at least partially defined by the first internal wall 310 and a second internal wall 320. The second internal wall 320 can be disposed opposite the first internal wall 310. The second internal wall 320 can extend between the component top 225 and the component bottom 230. The second internal wall 320 can be parallel with the first internal wall 320. The egress channel 315 can be configured to discharge fluid from the thermal component 120. The egress channel 315 can extend along the length of the thermal component 120. The egress channel 315 can extend along the first internal wall 310 and the second internal wall 320. The egress channel 315 can have any shape. For example, the egress channel 315 can be rectangular.

The thermal component 120 can have a plurality of egress channels 305. For example, the thermal component 120 can have a column of egress channels 305 extending between the component top 225 and the component bottom 230. The column of egress channels 305 can extend along and be partially defined by the first internal wall 310 and the second internal wall 320. Each of the egress channels 305 can be the same or different. For example, the channel system 300 can be asymmetrical such that the channel system 300 can provide more cooling proximate a cell top 110 of the battery cell 105 than proximate a cell bottom 115. The asymmetrical channel system 300 can, for example, have a larger first egress channel 305 at the component top 225 and a smaller egress channel 305 at a component bottom 230.

The channel system 300 can include at least one second ingress channel 325. The second ingress channel 325 can be at least partially defined by the second internal wall 320 and the second external wall 205. The second ingress channel 325 can be disposed opposite the first ingress channel 305. The second ingress channel 325 can be configured to receive a fluid to flow through the thermal component 120. The second ingress channel 325 can extend along the length of the thermal component 120. The second ingress channel 325 can extend along the second external wall 210. The heat from a second battery cell 105 can transfer through the second external wall 210 into the fluid flowing through the second ingress channel 325. The second ingress channel 325 can have any shape. For example, the second ingress channel 325 can be rectangular.

The thermal component 120 can have a plurality of second ingress channels 325. For example, the thermal component 120 can have a column of second ingress channels 325 extending between the component top 225 and the component bottom 230. The column of second ingress channels 325 can extend along and be partially defined by the second external wall 205. Each of the second ingress channels 325 can be the same or different. For example, the channel system 300 can be asymmetrical such that the channel system 300 can provide more cooling proximate a cell top 110 of the battery cell 105 than proximate a cell bottom 115. The asymmetrical channel system 300 can, for example, have a larger second ingress channel 325 at the component top 225 and a smaller second ingress channel 325 at a component bottom 230.

A first ingress channel 305 can be disposed on a first side of an egress channel 315 and a second ingress channel 325 can be disposed on a second side of the egress channel 315. For example, the first ingress channel 305 and the egress channel 315 can share the first internal wall 310. The second ingress channel 325 and the egress channel 315 can share the second internal wall 310.

The number of first ingress channels 305 can be the same as or different than the number of second ingress channels 325. The number of egress channels 315 can be the same as or different than the number of ingress channels 305, 325. For example, the channel system 300 can have a first ingress channel 305 and a second ingress channel 325 merge into (e.g., be fluidly coupled with an egress channel 315 (e.g., one first ingress channel 305 and one second ingress channel 325 for every egress channel 315). The channel system 300 can have a plurality of first ingress channels 305 and a plurality of second ingress channels 325 merge into (e.g., be fluidly coupled with) an egress channel 315. First ingress channels 305 and second ingress channels 325 that are fluidly coupled with the same egress channel 315 can be considered corresponding first and second ingress channels 305, 325. The coupling between the ingress channels 305, 325 and the egress channel 315 can be at an end of the thermal component 120.

Corresponding first and second ingress channels 305, 325 can have a combined ingress cross-sectional area. The egress channel 315 can have an egress cross-sectional area. The combined ingress cross-sectional area can be equal to, less than, or greater than the egress cross-sectional area. For example, the combined ingress cross-sectional area can be greater than the egress cross-sectional area such that the flow rate of the fluid flowing though the corresponding ingress channels 305, 325 can be less than the flow rate of the fluid flowing through the egress channel 315.

The internal and external walls can be the same or different. For example, the external walls 205, 210 can have a first, external thickness. The internal walls 310, 320 can have a second, internal thickness. The external thickness can be less than, equal to, or greater than the internal thickness. For example, the external thickness can be less than the internal thickness to facilitate greater heat transfer between the battery cell 105 and the fluid in an ingress channel 305, 325 than between the fluid in the ingress channels 305, 325 and the fluid in the egress channel 315. The external walls 205, 210 can be made of a first, external material. The internal walls 310, 320 can be made of a second, internal material. The external material can be the same or different than the internal material. For example, the external material can be a conductive material (e.g., aluminum). The internal material can be an insulative material (e.g., plastic).

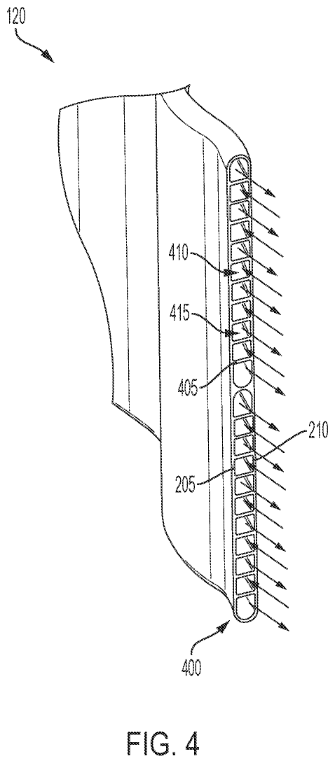

FIG. 4 depicts an example channel system 400 of a thermal component 120. For example, channel system 250 of thermal component 120 can be or include channel system 400. The channel system 400 can include at least one internal wall 405. The internal wall 405 can extend between the first external wall 205 and the second external wall 210. The channel system 400 can include a plurality of internal walls 405. The internal walls 405 can divide the inner volume 215 of the thermal component 120 into a plurality of channels. For example, the channel system 400 can include at least one ingress channel 410 and one egress channel 415. The channel system can have a plurality of ingress channels 410 and a plurality of egress channels 415. The channel system 400 can have a single column of channels comprising the plurality of ingress and egress channels 410, 415. The plurality of ingress and egress channels 410, 415 can be arranged to be alternating such an ingress channel 410 can disposed adjacent to only egress channels 415, and egress channels 415 can be disposed adjacent to only ingress channels 410.

The channel system 400 can be configured such that each ingress channel 410 can have a corresponding egress channel 415. For example, an ingress channel 410 can be fluidly coupled with an egress channel 415 such that fluid from the ingress channel 410 can flow from the ingress channel 410 to the first egress channel 415. The ingress channel 410 can be coupled with the egress channel 415 at an end of the thermal component 120.

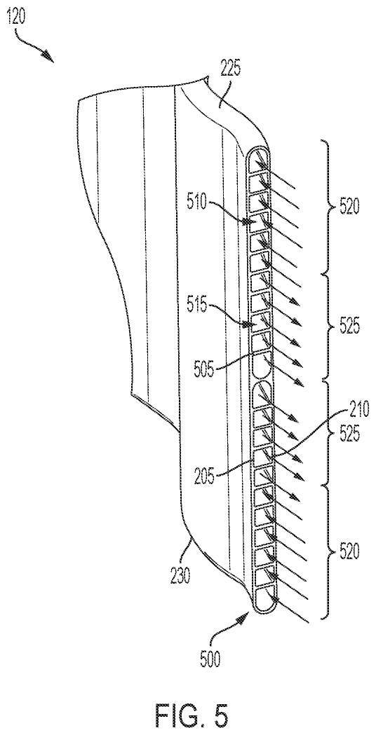

FIG. 5 depicts an example channel system 500 of a thermal component 120. For example, channel system 250 of thermal component 120 can be or include channel system 500. The channel system 500 can include at least one internal wall 505. The internal wall 505 can extend between the first external wall 205 and the second external wall 210. The channel system 500 can include a plurality of internal walls 505. The internal walls 505 can divide the inner volume 215 of the thermal component 120 into a plurality of channels. For example, the channel system 500 can include at least one ingress channel 510 and one egress channel 515. The channel system can have a plurality of ingress channels 510 and a plurality of egress channels 515. The channel system 500 can have a single column of channels comprising the plurality of ingress and egress channels 510, 515. At least some of the ingress channels 510 can be clustered together and at last some of the egress channels 515 can be clustered together. For example, a first subset of ingress channels 510 can be disposed proximate the component top 225. The first subset of ingress channels 510 can be a first ingress channel set 520. A second subset of ingress channels 510 can be disposed proximate the component bottom 230. The second subset of ingress channels 510 can be a second ingress channel set 520.

The egress channels 515 can be disposed between the first and second ingress channel sets 520. The egress channels 515 can be arranged as a single egress channel set 525 (e.g., include all of the egress channels 515), or can be arranged as multiple egress channel sets 525 (e.g., a first subset and a second subset of the egress channels 515). With a single egress channel set 525, the ingress channels 510 of the first ingress channel set 520 and the ingress channels 510 of the second ingress channel set 520 can be fluidly coupled with the egress channels 515 of the egress channel set 525. Each ingress channel 510 can be fluidly coupled with a corresponding egress channel 515, or a plurality of ingress channels 510 can merge together to be fluidly coupled with the egress channel 515. For example, the channel system 500 can have the same number of ingress channels 510 as egress channels 515, or the channel system 500 can have more or less ingress channels 510 than egress channels 515.

With a first egress channel set 525 and a second egress channel set 525, the first ingress channel set 520 can be fluidly coupled with the first egress channel set 525 and the second ingress channel set 520 can be fluidly coupled with the second egress channel set 525. The plurality of ingress channels 510 of the first ingress channel set 520 can couple individually with egress channels 515 of the first egress channel set 525 or the ingress channels 510 can merge to couple with the egress channels 515. The same can apply to the second ingress channel set 520 and the second egress channel set 525.

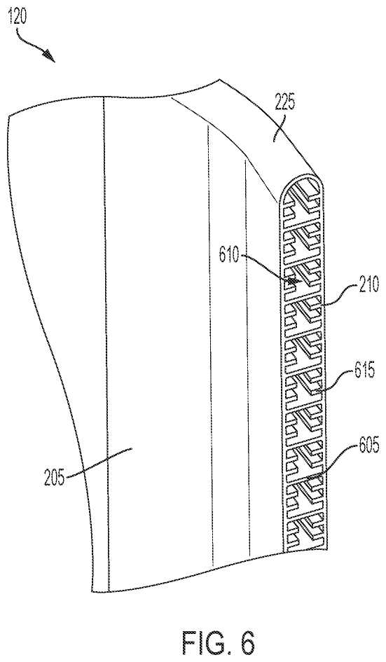

FIG. 6 depicts an example channel system 600 of a thermal component 120. For example, channel system 250 can be or include channel system 600. The channel system 600 can include at least one internal wall 605. The internal wall 605 can extend between the first external wall 205 and the second external wall 210. The channel system 600 can include a plurality of internal walls 605. The internal walls 605 can divide the inner volume 215 of the thermal component 120 into a plurality of channels 610. The channel system 600 can include at least one fin 615 disposed in a channel 610. The fin 615 can be configured to increase heat transfer between the battery cell 105 and the thermal component 120. The fin 615 can extend into a channel 610 from at least one of the first external wall 205, the second external wall 210, or an internal wall 605. The fin 615 can extend a length of the thermal component 120.

The channel system 600 can include a plurality of fins 615. For example, a plurality of fins 615 can extend into a single channel 610, plurality of fins 615 can extend into a plurality of channels 610, or a combination thereof. A fin 615 can be incorporated in any of the previously mentioned channel systems 250, 300, 400, 500. For example, at least one fin 615 can be disposed in an ingress channel 305, 325 or an egress channel 315 of the channel system 300. At least one fin 615 can be disposed in an ingress channel 410 or an egress channel 415 of channel system 400. At least one fin 615 can be disposed in an ingress channel 510 or an egress channel 515 of channel system 500. A fin 615 can be disposed in only one of the ingress or egress channels of the channel systems 250, 300, 400, 500, 600. For example, only the ingress channels can include one or more fins 615.

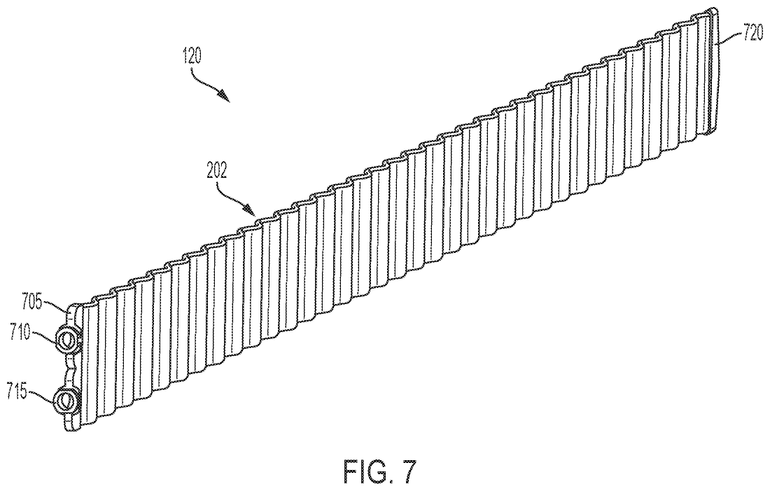

FIG. 7 depicts an example thermal component 120. The thermal component 120 can include at least fitting disposed at a first end of the body 202. For example, the thermal component 120 can include at least one first fitting, shown as transfer fitting 705. The transfer fitting 705 can be disposed at a first end of the body 202. The transfer fitting 705 can provide at least one passage to facilitate a transfer of fluid between the thermal component 120 and a fluid source. For example, the transfer fitting 705 can have at least one first opening, shown as inlet 710. The thermal component 120 can receive a fluid from the fluid source via the inlet 710. The transfer fitting 705 can have at least one second opening, shown as outlet 715. The thermal component 120 can discharge the fluid to the fluid source via the outlet 715. The inlet 710 and the outlet 715 can be interchangeable.

The transfer fitting 705 can be fluidly coupled with the ingress and egress channels of the thermal component 120. For example, the transfer fitting 705 can disperse the fluid from the fluid source to the plurality of ingress channels within the body 202 of the thermal component 120. For example, the transfer fitting 705 can provide the fluid from the fluid source to the first ingress channel 305 and the second ingress channel 325. The transfer fitting 705 can fluidly couple the inlet 710 with a plurality of ingress channels. The transfer fitting 705 can merge the fluid from the plurality of egress channels within the body 202 of the thermal component 120. For example, the transfer fitting 705 can fluidly couple the plurality of egress channels with the outlet 715.

The thermal component 120 can include at least one second fitting, shown as transition fitting 720. The transition fitting 720 can be disposed at a second end of the body 202 opposite the first end. The transition fitting 720 can provide at least one passage to facilitate a transfer of the fluid from the ingress channels to the egress channels. For example, the transition fitting 720 can fluidly couple at least one ingress channel with at least one egress channel. The transition fitting 720 can merge fluid from a plurality of ingress channels into a single egress channel. For example, the transition fitting 720 can fluidly couple the first ingress channel 305 and the second ingress channel 325 with the egress channel 315. The transition fitting 720 can disperse fluid from a single ingress channel into a plurality of egress channels. The transition fitting 720 can mix fluid from a plurality of ingress channels such that the mixed fluid can flow through at least one egress channel.

A temperature of the fluid received at the inlet 710 can be lower than the temperature of the fluid discharged at the outlet 715. For example, the fluid can enter the thermal component 120 via the inlet 710 at a first temperature. The fluid can flow through the ingress channels of the thermal component 120 from the first end of the body 202 to the second end of the body 202 and receive heat from the battery cells 105 while in the ingress channels. The fluid can transition from the ingress channels to the egress channels via the transition fitting 720 to flow from the second end of the body 202 back to the first end via the egress channels. The fluid can discharge from the thermal component 120 via the outlet 715 of the transfer fitting 705. The discharged fluid can have a second temperature that is greater than the first temperature based on the heat received from the battery cells 105.

A temperature of the fluid received at the inlet 710 can be higher than the temperature of the fluid discharged at the outlet 715. For example, the fluid can enter the thermal component 120 via the inlet 710 at a first temperature. The fluid can flow through the ingress channels of the thermal component 120 from the first end of the body 202 to the second end of the body 202 and provide heat to the battery cells 105 while in the ingress channels. The fluid can transition from the ingress channels to the egress channels via the transition fitting 720 to flow from the second end of the body 202 back to the first end via the egress channels. The fluid can discharge from the thermal component 120 via the outlet 715 of the transfer fitting 705. The discharged fluid can have a second temperature that is lower than the first temperature based on the heat transferred to the battery cells 105.

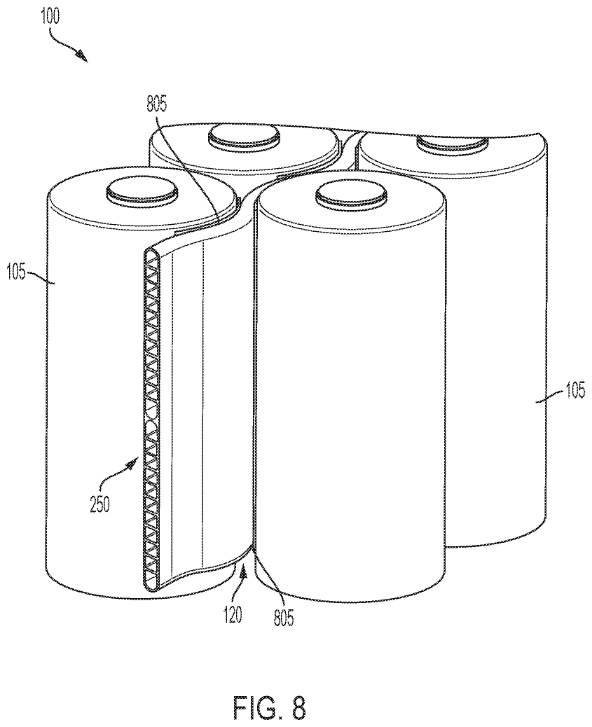

FIG. 8 depicts a portion of an example battery assembly 100. The battery assembly 100 can include at least one battery cell 105 coupled with the thermal component 120. For example, the battery cell 105 can be coupled with the thermal component 120 via a coupling mechanism 805. The coupling mechanism 805 can be, for example, an adhesive. The adhesive can be disposed between a side of the battery cell 105 and an external wall 205, 210 of the thermal component 120. For example, at least a portion of the coupling mechanism 805 can be disposed in a concave portion 240 of an exterior wall 205, 210. The coupling mechanism 805 can be thin such that heat can transfer through the coupling mechanism 805 from the battery cell 105 to the thermal component 120. The coupling mechanism 805 can be conductive such that heat can transfer through the coupling mechanism 805 from the battery cell 105 to the thermal component 120.

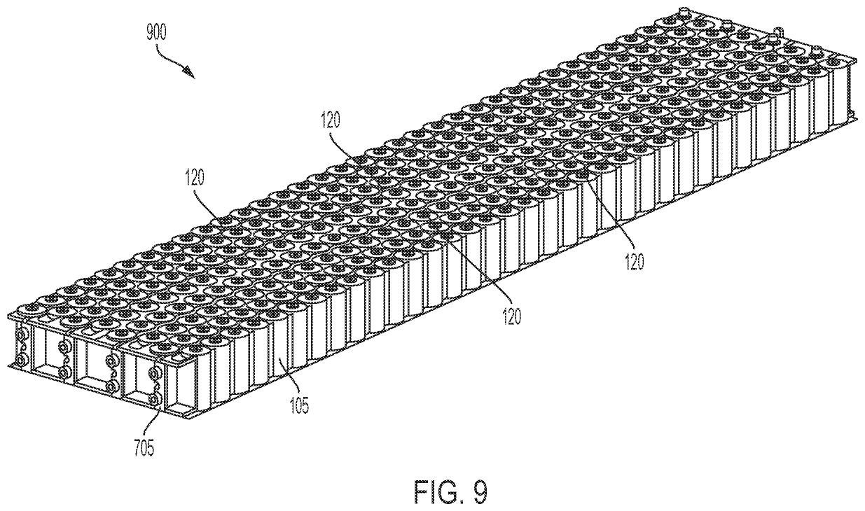

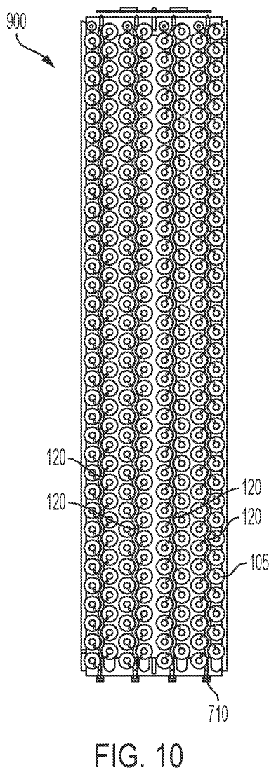

FIGS. 9 and 10 depict an example battery system, shown as battery module 900. A battery module 900 can include a plurality of battery assemblies 100. For example, the battery module 900 can have a plurality of thermal components 120. The thermal components 120 can extend parallel with each other. The thermal components 120 can extend the length of the battery module 900. Each thermal component 120 can be coupled with a plurality of battery cells 105. For example, each thermal component 120 can have a first set of battery cells 105 disposed on a first side of the body 202 and interfacing with the first external wall 205. Each thermal component 120 can have a second set of battery cells 105 disposed on a second side of the body 202 and interfacing with the second external wall 210.

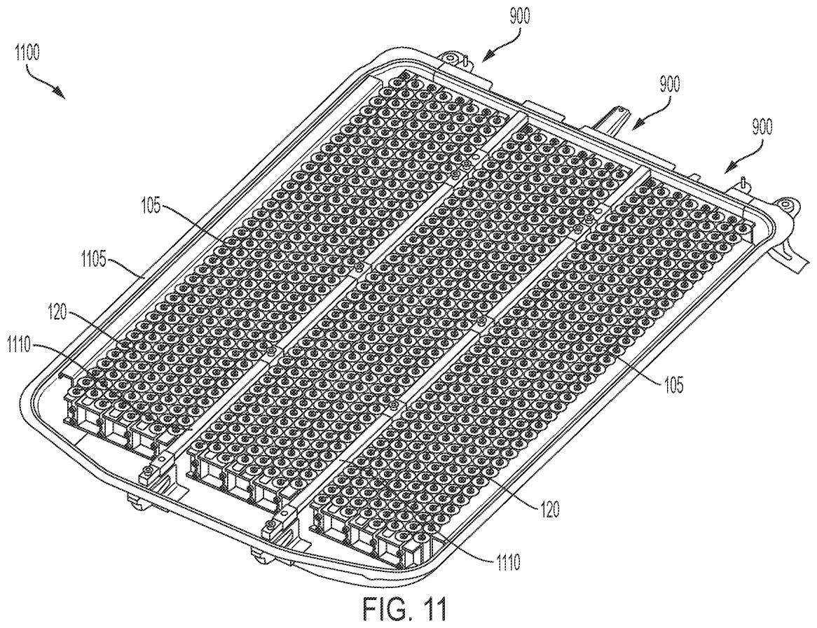

FIG. 11 depicts an example battery pack 1100. The battery pack 1100 can include at least one housing 1105. The battery pack 1100 can include at least one thermal component 120 disposed in the housing 1105. The thermal component 120 can extend along a length of the battery pack 1100. For example, the thermal component 120 can extend along a majority of the length of the battery pack 1100 such that a transfer fitting 705 is disposed at or proximate to a first end of the battery pack 1100 and a transition fitting 720 is disposed at or proximate to a second end of the battery pack 1100.

The battery pack 1100 can include a plurality of battery cells 105 disposed in the housing 1105. For example, a plurality of battery cells 105 can couple with the thermal component 120. A first set of the battery cells 105 can be disposed on a first side of the thermal component 120 and interface with a first external wall 205. A second set of the battery cells 105 can be disposed on a second side of the thermal component 120 an interface with a second external wall 210. The thermal component 120 can cool the battery cells 105. For example, heat generated by the battery cells 120 can transfer to the fluid flowing through the channel system 250. The fluid can carry the heat out of the thermal component 120 and away from the battery cells 120.

The battery pack 1100 can include at least one battery module 900. The battery module 900 can include a plurality of thermal components 120. For example, a battery module 900 can include four thermal components 120. Each thermal component 120 can couple with a plurality of battery cells 120. For example, each thermal component 120 can interface with a first set of battery cells 120 via a first external wall 205 and interface with a second set of battery cells 120 via a second external wall 210. The battery pack 1100 can include a plurality of battery modules 900.

The battery pack 1100 can include at least one structural member 1110. The structural member 1110 can provide structural support to the battery pack 1100. For example, the structural member 1110 can absorb loads applied to the battery 1100. A structural member 1110 can be disposed between adjacent battery modules 900. For example, the structural member 1110 can be disposed between a first battery module 900 and a second battery module 900. The battery pack 1100 can, for example, include three battery modules 900. A first structural member 1110 can be disposed between a first and a second battery module 900 and a second structural member 1110 can be disposed between the second and a third battery module 900. The battery pack 1100 can include a plurality of battery modules 900 without structural members 1110 disposed between battery modules 900.

The battery modules 900 can be disposed within the battery pack 1100. The battery modules 900 can include battery cells 105 that are cylindrical cells or prismatic cells, for example. The battery module 900 can operate as a modular unit of battery cells 105. For example, a battery module 900 can collect current or electrical power from the battery cells 105 that are included in the battery module 900 and can provide the current or electrical power as output from the battery pack 1100. The battery pack 1100 can include any number of battery modules 900. For example, the battery pack 1100 can have one, two, three, four, five, six, seven, eight, nine, ten, eleven, twelve or other number of battery modules 900 disposed in the housing 1105. The battery pack 1100 can include or define a plurality of areas for positioning of the battery module 900. The battery modules 90 can be square, rectangular, circular, triangular, symmetrical, or asymmetrical. In some examples, battery modules 900 may be different shapes, such that some battery modules 900 are rectangular but other battery modules 900 are square shaped, among other possibilities. The battery module 900 can include or define a plurality of slots, holders, or containers for a plurality of battery cells 120.

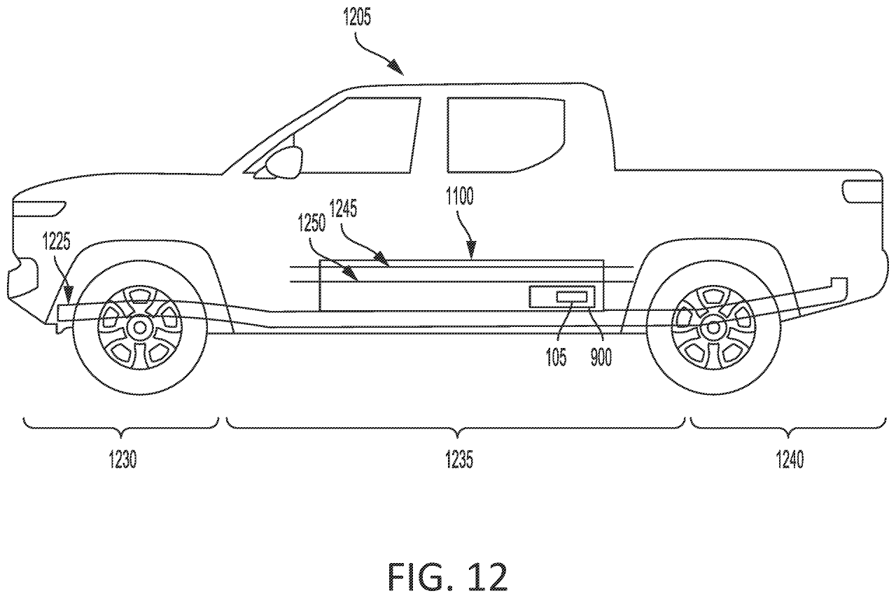

FIG. 12 depicts is a cross-sectional view of an example electric vehicle 1205 installed with at least one battery pack 1100. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Yet, it should also be noted that battery pack 1100 may also be used as an energy storage system to power a building, such as a residential home or commercial building. Electric vehicles 1205 can be fully electric or partially electric (e.g., plug-in hybrid) and further, electric vehicles 1205 can be fully autonomous, partially autonomous, or unmanned. Electric vehicles 1205 can also be human operated or non-autonomous. Electric vehicles 1205 such as electric trucks or automobiles can include on-board battery packs 1100, battery modules 900, or battery cells 105 to power the electric vehicles 1205. Battery cells 105 can be included in battery modules 900 or battery packs 1100 to power components of the electric vehicle 1205. The battery cell 105 can be disposed in the battery module 900, the battery pack 1100, or in a battery array installed in the electric vehicle 1205.

The electric vehicle 105 can include a chassis 1225 (e.g., a frame, internal frame, or support structure). The chassis 1225 can support various components of the electric vehicle 1205. The chassis 1225 can span a front portion 1230 (e.g., a hood or bonnet portion), a body portion 1235, and a rear portion 1240 (e.g., a trunk, payload, or boot portion) of the electric vehicle 1205. The battery pack 900 can be installed or placed within the electric vehicle 1205. For example, the battery pack 900 can be installed on the chassis 1225 of the electric vehicle 1205 within one or more of the front portion 1230, the body portion 1235, or the rear portion 1240. The battery pack 900 can include or connect with at least one busbar, e.g., a current collector element. For example, the first busbar 1245 and the second busbar 1250 can include electrically conductive material to connect or otherwise electrically couple the battery modules 900 or the battery cells 105 with other electrical components of the electric vehicle 1205 to provide electrical power to various systems or components of the electric vehicle 1205.

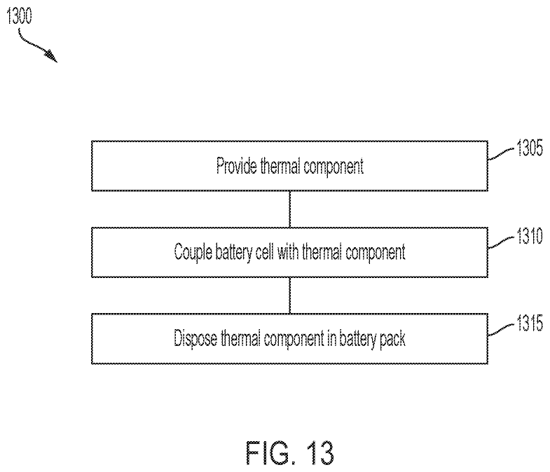

FIG. 13 depicts an example method 1300 to assemble a battery pack 1100. Method 1300 can include providing a thermal component 120 (step 1305). The thermal component 120 can include a body 202. The body 202 can have or define a channel system 250. The channel system 250 can include an egress channel (e.g., egress channel 315). The egress channel 315 can be defined at least partially by a first internal wall 310 and a second internal wall 320. The channel system 250 can include a first ingress channel (e.g., ingress channel 305). The ingress channel 305 can be defined at least partially by the first internal wall 310 and a first external wall 205. The channel system 250 can include a second ingress channel (e.g., ingress channel 325). The ingress channel 325 can be defined at least partially by the second internal wall 320 and the second external wall 210. Step 1305 can include fluidly coupling the first ingress channel 305 and the second ingress channel 325 with the egress channel 315 via a fitting. For example, the first ingress channel 305 and the second ingress channel 325 can be coupled with the egress channel 315 via a transition fitting 720.

Method 1300 can include coupling a plurality of battery cells 105 with the thermal component 120 (step 1310). For example, a first subset of the plurality of battery cells 105 can be disposed on a first side of the thermal component 120. The first subset of battery cells 105 can interface with, either directly or indirectly (e.g., via an adhesive), the first external wall 205 of the thermal component 120. A second subset of the battery cells 105 can be disposed on a second side of the thermal component 120. The second subset of battery cells 105 can interface with, either directly or indirectly (e.g., via an adhesive), the second external wall 210 of the thermal component 120.

Method 1315 can include disposing the thermal component 120 in a battery pack 1100 (step 1315). For example, the battery pack 1100 can have a housing 1105. The thermal component 120 can be disposed in the housing 1105. The battery cells 105 coupled with the thermal component 120 can be disposed in the housing 1105. The thermal component 120 can be oriented to extend along a length of the battery pack 1100.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A thermal component, comprising:
an egress channel defined at least partially by a first internal wall and a second internal wall;
a first ingress channel defined at least partially by the first internal wall and a first external wall; and
a second ingress channel defined at least partially by the second internal wall and a second external wall.

2. The thermal component of claim 1, wherein the first ingress channel and the second ingress channel are fluidly coupled with the egress channel at an end of the thermal component.

3. The thermal component of claim 1, wherein the first internal wall is opposite the second internal wall such that the first ingress channel is opposite the second ingress channel.

4. The thermal component of claim 1, comprising:
the first external wall comprising a first concave portion configured to interface with a side of a first battery cell, the first external wall configured to transfer heat from the first battery cell to a coolant flowing through the first ingress channel; and
the second external wall comprising a second concave portion configured to interface with a side of a second battery cell, the second external wall configured to transfer heat from the second battery cell to a coolant flowing through the second ingress channel.

5. The thermal component of claim 1, comprising:
a wavy profile configured to at least partially surround a plurality of battery cells to increase an area of contact between the plurality of battery cells and the thermal component.

6. The thermal component of claim 1, comprising:
a height, the height based on a height of a jelly roll of a battery cell, the height of the thermal component to be greater than or equal to the height of the jelly roll.

7. The thermal component of claim 1, comprising:
a first fitting disposed at a first end of the thermal component, the first fitting configured to provide coolant to the first ingress channel and the second ingress channel; and
a second fitting disposed at a second end of the thermal component opposite the first end, the second fitting configured to fluidly couple the first ingress channel and the second ingress channel with the egress channel.

8. The thermal component of claim 1, wherein the first external wall and the second external wall are configured to extend along a length of a battery pack, the first external wall configured to interface with a first set of battery cells, and the second external wall configured to interface with a second set of battery cells.

9. The thermal component of claim 1, comprising:
the first ingress channel and the second ingress channel have a combined ingress cross-sectional area; and
the egress channel has an egress cross-sectional area, the egress cross-sectional area less than the combined ingress cross-sectional area to increase a flow rate through the egress channel.

10. The thermal component of claim 1, comprising:
the first external and the second external have an external thickness; and
the first internal and the second internal have an internal thickness, wherein the external thickness is less than the internal thickness.

11. The thermal component of claim 1, comprising:
a component top configured to be disposed adjacent to a top of a battery cell;
a component bottom opposite the component top, the component bottom configured to be disposed adjacent to a bottom of the battery cell; and
an asymmetrical channel system that extends between the component top and the component bottom, the asymmetrical channel system configured to provide more cooling at the component top than the component bottom.

12. A battery pack for an electric vehicle, comprising:
a housing;
a plurality of battery cells disposed in the housing; and
a thermal component disposed in the housing, the thermal component configured to interface with the plurality of battery cells, the thermal component extending along a length of the battery pack, the thermal component comprising:
an egress channel defined at least partially by a first internal wall and a second internal wall;
a first ingress channel defined at least partially by the first internal wall and a first external wall; and
a second ingress channel defined at least partially by the second internal wall and a second external wall.

13. The battery pack of claim 12, comprising:
a first fitting disposed at a first end of the thermal component, the first fitting configured to provide coolant to the first ingress channel and the second ingress channel; and
a second fitting disposed at a second end of the thermal component opposite the first fitting, the second fitting fluidly coupling the first ingress channel and the second ingress channel with the egress channel.

14. The battery pack of claim 12, comprising:
the plurality of battery cells comprising a first battery cell and a second battery cell;
the first battery cell configured to interface with the first external wall; and
the second battery cell configured to interface with the second external wall, the first battery cell offset from the first battery cell.

15. The battery pack of claim 12, wherein the plurality of battery cells are bonded to the thermal component via an adhesive.

16. The battery pack of claim 12, comprising:
the plurality of battery cells comprising a first set of battery cells and a second set of battery cells;
a plurality of thermal components including the thermal component, the plurality of thermal components comprising a first thermal component and a second thermal component, the first thermal component extending parallel to the second thermal component; and
the first set of battery cells interfacing with the first thermal component and the second set of battery cells interfacing with the second thermal component.

17. The battery pack of claim 12, comprising:
the housing comprising a plurality of modules; and
a plurality of thermal components including the thermal component, a set of thermal components of the plurality of thermal components disposed in each of the plurality of modules.

18. A method, comprising:
providing a thermal component, the thermal component comprising:
an egress channel defined at least partially by a first internal wall and a second internal wall;
a first ingress channel defined at least partially by the first internal wall and a first external wall; and
a second ingress channel defined at least partially by the second internal wall and a second external wall;
coupling a plurality of battery cells with the thermal component; and
disposing the thermal component in a housing of a battery pack.

19. The method of claim 18, comprising:
disposing a first subset of the plurality of battery cells on a first side of the thermal component to interface with the first external wall; and
disposing a second subset of the plurality of battery cells on a second side of the thermal component to interface with the second external wall.

20. The method of claim 18, comprising:
fluidly coupling the first ingress channel and the second ingress channel with the egress channel via a fitting.
